(19) United States
(12) Patent Application Publication
(10) Pub. No.: US 2026/0179001 A1
(43) Pub. Date: Jun. 25, 2026

(54) METHOD AND APPARATUS FOR CONTROLLING LIFE CYCLE OF CROWDS BASED ON USER PROFILE

(71) Applicant: SHENZHEN COOCAA NETWORK TECHNOLOGY CO., LTD., Shenzhen, Guangdong (CN)

(72) Inventors: Zhiguo WANG, Shenzhen (CN); Wanzheng MA, Shenzhen (CN)

(73) Assignee: SHENZHEN COOCAA NETWORK TECHNOLOGY CO., LTD., Shenzhen, Guangdong (CN)

(21) Appl. No.: 18/832,172

(22) PCT Filed: Dec. 15, 2023
(86) PCT No.: PCT/CN2023/139153

§ 371 Date: Jul. 23, 2024

(30) Foreign Application Priority Data
Feb. 7, 2023 (CN) 202310125907.X

(51) Int. Cl. G06Q 10/0631

(52) U.S. Cl. CPC G06Q 10/06311

(57) ABSTRACT

Disclosure is a method and apparatus for controlling a life cycle of crowds based on user profile. The method includes steps of: obtaining a configured crowd command and an accessory expiry date during a production of crowds, obtaining a computing cycle of the crowds; performing a calculation based on a query statement of the crowd command, counting daily crowds, monthly crowds, and quarterly crowds to screen valid crowds and invalid crowds based on a preset rule; and controlling the invalid crowds to be removed, judging the valid crowds to determine whether to modify a removal date, at the same time, controlling a quantity of total people of the crowds run daily within a preset number. The present disclosure formulates one set of thorough life cycle of the crowds, primarily solving the extremely waste of the invalid crowds, thereby providing convenience for a user.

### FIELD OF THE DISCLOSURE

The present disclosure relates to the technical field of data processing, in particular to a method and an apparatus for controlling a life cycle of crowds based on user profile.

### BACKGROUND

User profile refers to a tagged-user model abstracted based on user attributes, user preferences, user living habits, user behaviors, and other information.

A user-profile system or platform is extremely common in a big-data company. The number of crowds continues to increase, but the user-profile system has computing limit and storage limit. This leads to a problem, computing of the crowds is slow or computing of daily crowds cannot be fully completed, thus causing business crowds to lose valuable delivery opportunities.

Therefore, the prior art still needs to be improved.

### BRIEF SUMMARY OF THE DISCLOSURE

According to the above-mentioned defect of the prior art, a technical problem to be solved by the present disclosure is to provide a method, apparatus, intelligent terminal, and storage medium for controlling a life cycle of crowds based on user profile, so as to formulate one set of thorough life cycle of the crowds, thereby primarily solving extreme waste of invalid crowds and providing convenience for a user.

In order to solve the above-mentioned technical problem, in a first aspect, the present disclosure provides a method for controlling a life cycle of crowds based on user profile based on OTT, including steps of:
obtaining a configured crowd command and an accessory expiry date during a production of crowds, obtaining a computing cycle of the crowds;
performing a calculation based on a query statement of the crowd command, counting daily crowds, monthly crowds, and quarterly crowds to screen valid crowds and invalid crowds based on a preset rule; and
controlling the invalid crowds to be removed, judging the valid crowds to determine whether to modify a removal date, at the same time, controlling a quantity of total people of the crowds run daily within a preset number.

In one implementation, before the step of obtaining a configured crowd command and an accessory expiry date during a production of crowds, obtaining a computing cycle of the crowds, the method includes steps of:
creating crowd data, and configuring the corresponding crowd command and the accessory expiry date for the created crowd data.

In one implementation, the step of performing a calculation based on a query statement of the crowd command, includes steps of:
parsing the crowd command, obtaining an execution statement of the crowds for calculation and storage.

In one implementation, the step of performing a calculation based on a query statement of the crowd command, includes steps of:
controlling starting a scheduled task, counting the crowds in past one day, the crowds in past one week, the crowds in past one month, and the crowds in past three months, obtaining a quantity of total executed people of the crowds in the past one day, a quantity of total executed people of the crowds in the past one week, a quantity of total executed people of the crowds in the past one month, and a sorting order of quantities of total executed people of each crowd in the past three months respectively, and obtaining both the sorting order of quantities of total executed people of the each crowd in the past three months and the expiry date of the each crowd.

In one implementation, the step of counting daily crowds, monthly crowds, and quarterly crowds to screen valid crowds and invalid crowds based on a preset rule, includes steps of:
counting both a sorting order of quantities of total executed people of each crowd in past three months and the expiry date of the each crowd to screen the valid crowds and the invalid crowds; and
if a quantity of total execution times of one crowd in previous two months is less than 10 times, or a quantity of total people of the one crowd in past one month is less than 100,000 users, determining the one crowd as invalid, and issuing a notification at a preset date.

In one implementation, the step of counting daily crowds, monthly crowds, and quarterly crowds to screen valid crowds and invalid crowds based on a preset rule, includes steps of:
setting the expiry date of the crowds in advance based on the crowd command to determine the invalid crowds;
determining the invalid crowds based on a query duration of the crowds being higher than a first preset value;
determining the invalid crowds based on a repetition value of the crowds in past three months being lower than a second preset value;
determining the invalid crowds based on both data volume of the crowds being lower than a third preset value, and the crowds being run daily; or
determining the invalid crowds based on the quantity of total people of the crowds run daily being more than 80% of a load of a profile platform.

In one implementation, the step of controlling the invalid crowds to be removed, judging the valid crowds to determine whether to modify a removal date, at the same time, controlling a quantity of the crowds run daily within a preset number, includes steps of:
destroying the invalid crowds and modifying the computing cycle to be valid by crowd counting and crowd controlling.

An apparatus for controlling a life cycle of crowds based on user profile is provided, including:
creating module, used for creating crowd data, configuring a corresponding crowd command and an accessory expiry date for the created crowd data;
obtaining module, used for obtaining the configured crowd command and the accessory expiry date during a production of crowds, obtaining a computing cycle of the crowds;
counting and screening module, used for performing a calculation based on a query statement of the crowd command, counting daily crowds, monthly crowds, and quarterly crowds to screen valid crowds and invalid crowds based on a preset rule; and
controlling module, used for controlling the invalid crowds to be removed, judging the valid crowds to determine whether to modify a removal date, at the same time, controlling a quantity of total people of the crowds run daily within a preset number.

An intelligent terminal is provided, including a memory, and one or more programs, and the one or more programs are stored in the memory, and are configured to implement the methods above when one or more processors execute the one or more programs.

A non-transitory computer-readable storage medium is provided. When a command of the storage medium is executed by a processor of an electronic device, the electronic device implements the methods above.

Beneficial effects: compared with the prior art, the present disclosure provides a method for controlling a life cycle of crowds based on user profile. The present disclosure formulates one set of thorough method for controlling the life cycle of the crowds, and controls the invalid crowds to be removed in a timely manner, primarily solving that the computing and storage resource of the user-profile system is occupied by the invalid crowds, and reducing resource waste, thereby improving resource-utilization rate of the user-profile system, and providing convenience for a user.

### BRIEF DESCRIPTION OF THE DRAWINGS

FIG. 1 is a flow chart of an implementation of a method for controlling a life cycle of crowds based on user profile provided by an embodiment of the present disclosure.

FIG. 2 is a schematic diagram of a stage of crowds of user profile in a method for controlling a life cycle of the crowds based on user profile provided by an embodiment of the present disclosure.

FIG. 3 is a flow chart of a life cycle of crowds in a method for controlling the life cycle of the crowds based on user profile provided by an embodiment of the present disclosure.

FIG. 4 is a functional block of an apparatus for controlling a life cycle of crowds based on user profile provided by an embodiment of the present disclosure.

FIG. 5 is a functional block of an internal structure of an intelligent terminal provided by an embodiment of the present disclosure.

### DETAILED DESCRIPTION OF EMBODIMENTS

In order to make the purposes, technical schemes, and effects of the present disclosure clearer and more explicit, the present disclosure is further described in detail below with reference to the accompanying drawings and embodiments. It should be understood that the specific embodiments described here are only used to explain the present disclosure, not to limit the present disclosure.

A user-profile system or platform is extremely common in a big-data company. The number of crowds continues to increase, but the user-profile system has computing limit and storage limit. This leads to a problem, computing of the crowds is slow or computing of daily crowds cannot be fully completed, thus causing business crowds to lose valuable delivery opportunities.

In order to solve the above-mentioned technical problem, an embodiment of the present disclosure provides a method for controlling a life cycle of crowds based on user profile, so as to formulate one set of thorough life cycle of the crowds, thereby primarily solving extreme waste of invalid crowds. First a computing cycle is set during a production of crowds, and then invalid crowds are destroyed and the computing cycle is modified to be valid by crowd counting and crowd controlling, ensuring that computed daily crowds are below an upper limit of an user-profile system, thereby providing convenience for a user.

### Exemplary Method

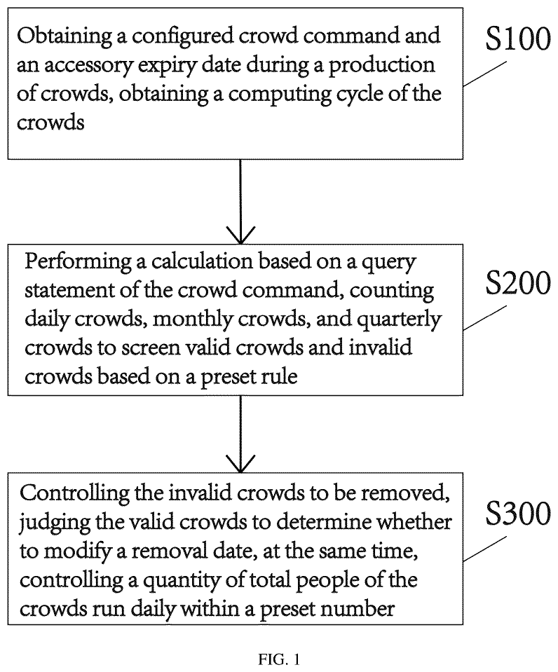

The method of the present embodiment may be applied to an intelligent terminal. During an implementation, as shown in FIG. 1, the method includes the following steps.

Step S100, obtaining a configured crowd command and an accessory expiry date during a production of crowds, and obtaining a computing cycle of the crowds.

Crowd data of the present disclosure is crowd data of user profile, and user profile refers to a tagged-user model abstracted based on user attributes, user preferences, user living habits, user behaviors, and other information.

In the embodiments of the present disclosure, during a creation of the crowd data (the production of the crowds), the created crowd data is configured with corresponding crowd command and accessory expiry date. In the present disclosure, the creation of the crowd data (the production of the crowds) relates to a configuration of the crowd command and the expiry date of the crowds. The following is an example of the production of the crowds:

```
  {
    “creator”: “Mr. Yu”, // creator
    “crowdDesc”: “”, // description of crowd
    “crowdId”: 114519, // ID of crowd
    “crowdName”: “[12450]unexpired user members of karaoke +
expired users of karaoke who have been playing for more than 15 minutes
since the last 7 days”, // name of crowd
    “crowdType”: 2, // type of crowd
    “expiry”: “2022-11-01”, // expiry date of crowd
    “sql”: {“”}, // execution statement of crowd
    “version”: “2022090501”, // version of crowd
    ...
  }.
```

In an implementation of the embodiments of the present disclosure, the configured crowd command and the accessory expiry date both similar to the above-mentioned example of the production of the crowds are obtained, such as the above ““2022-11-01”, //expiry date of crowd”, and the computing cycle of the crowds is obtained.

Step S200, performing a calculation according to a query statement of the crowd command, and performing a crowd counting for daily, monthly, and quarterly crowds to screen valid crowds and invalid crowds according to a preset rule.

In the present step, the calculation is performed mainly according to the query statement of the crowd command, and the crowd counting is performed mainly for the daily, monthly, and quarterly crowds to screen the valid crowds and the invalid crowds according to the preset rule.

In the present disclosure, the crowd data of user profile is processed. When processing the crowd data, it first needs to parse the crowd command, and obtain the execution statement of the crowds for calculation and storage.

Then the crowd counting is performed, in the step of performing the crowd counting, a scheduled task is started. For example, one scheduled task is started daily; the crowds in past one day, past one week, past one month, and past three months are counted; the number of total executed people of the crowds in the past one day, the number of total executed people of the crowds in the past one week, the number of total executed people of the crowds in the past one month, and a sorting order of the numbers of total executed people of each crowd in the past three months are respectively obtained; both the sorting order of the numbers of total executed people of the each crowd in the past three months, and the expiry date of the each crowd are obtained. This is for being output to a crowd controlling module. Of course, in one implementation, some crowds may be executed once a day.

In an implementation of the embodiments of the present disclosure, the sorting order of the numbers of total executed people of the each crowd in the past three months, and the expiry date of the each crowd both are counted to screen the valid crowds and the invalid crowds. For example, if the number of total execution times of a crowd in the previous two months is less than 10 times, or the number of total people of a crowd in the latter month is less than 100,000 users, the crowd is determined as one of the invalid crowds, and a notification is issued at a preset date. It is convenient for subsequent steps to separately process the invalid crowds and the valid crowds.

In a further embodiment of the present disclosure, the step of performing the crowd counting for daily, monthly, and quarterly crowds to screen the valid crowds and the invalid crowds according to the preset rule includes the following situations:
In a first preset rule, setting the expiry date of the crowds in advance according to the crowd command to determine the invalid crowds; that is to say, setting the expiry date of the crowds in advance according to the crowd command during the production of the crowds to determine the invalid crowds; if crowd data of a crowd reaches the expiry date, the crowd is determined to be an invalid crowd;
In a second preset rule, determining the invalid crowds if a query duration of the crowds exceeds a first preset value; for example, if the query duration of a crowd is too long, such as exceeding one hour, the crowd is determined to be an invalid crowd; logic can be written as a fixed data warehouse table;
In a third preset rule, determining the invalid crowds if a repetition value of the crowds in the past three months is lower than a second preset value; for example, if the repetition value of a crowd in the past three months is lower than 10 times, the crowd is determined to be an invalid crowd;
In a fourth preset rule, determining the invalid crowds if both data volume of the crowds is lower than a third preset value and the crowds is run daily; for example, if both the data volume of a crowd is less than 100,000 users and the crowd is run daily, the crowd is determined to be an invalid crowd;
Or in a fifth preset rule, determining the invalid crowds if the number of total people of the crowds run daily is more than 80% of a load of a profile platform; for example, if the number of total people of the crowds run daily is more than 80% of the load of the profile platform. Then a computing resource is increased or a higher filtering condition is set.

In the embodiments of the present disclosure, step S300 is after the step of performing the calculation according to the query statement of the crowd command, and performing the crowd counting for daily, monthly, and quarterly crowds to screen the valid crowds and the invalid crowds according to the preset rule.

Step S300, controlling the invalid crowds to be removed, judging the valid crowds to determine whether to modify a removal date, and at the same time, controlling the number of total people of the crowds run daily within a preset number.

In the embodiments of the present disclosure, according to both the sorting order of the numbers of total executed people of the each crowd in the past three months obtained by crowd counting, and the expiry date of the each crowd, a corresponding judgment is made. If the number of total execution times of a crowd in the previous two months is lower than 10 times, or the number of total people of a crowd in the latter one month is less than 100,000 users, the crowd is determined as one of the invalid crowds. And when there is one week before the expiry date, the relevant users are notified.

In the embodiments of the present disclosure, a main control method adopted is to control the invalid crowds to be removed, judge the valid crowds to determine whether to modify the removal date, and at the same time, control the number of total people of the crowds run daily within the specified number. The present disclosure uses crowd counting and crowd controlling to destroy the invalid crowds and modify the computing cycle to be valid. The present disclosure uses an invalid-crowd list provided by crowd controlling to move the invalid crowds to a historical-crowd database.

It can be seen from the above that, by formulating one set of thorough method for controlling the life cycle of the crowds, the present disclosure controls the invalid crowds to be removed in a timely manner, primarily solving that the computing and storage resource of the user-profile system is occupied by the invalid crowds, and reducing resource waste, thereby improving resource-utilization rate of the user-profile system, and providing convenience for a user.

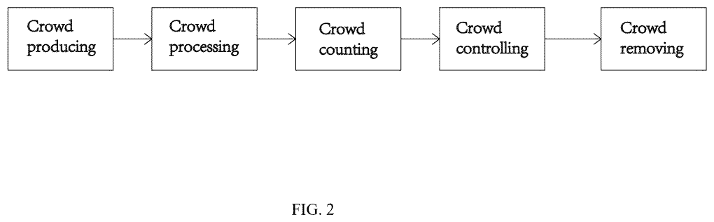

It can be seen that, as shown in FIG. 2, in an implementation of the present disclosure, the crowds of user profile go through five stages in total: crowd producing, crowd processing, crowd counting, crowd controlling, and crowd removing. Details are as follows:
Crowd producing: it is a step of configuring both the crowd command and the expiry date of the crowds, as described above;
Crowd processing: it is a step of performing the calculation and storage according to the crowd command, as described above;
Crowd counting: it is a step of counting the crowds by grouping, by day, by month, and by quarter, and at the same time, the crowds are run once and accumulated once, as described above;
Crowd controlling: it is a step of judging the crowds based on the expiry date and the number of counting times, and determining the invalid crowds and valid crowds, as described above;
Crowd removing: it is a step of removing the crowds; when the crowds are removed, the crowds are no longer run, but the crowds can be run again under human intervention, as described above.

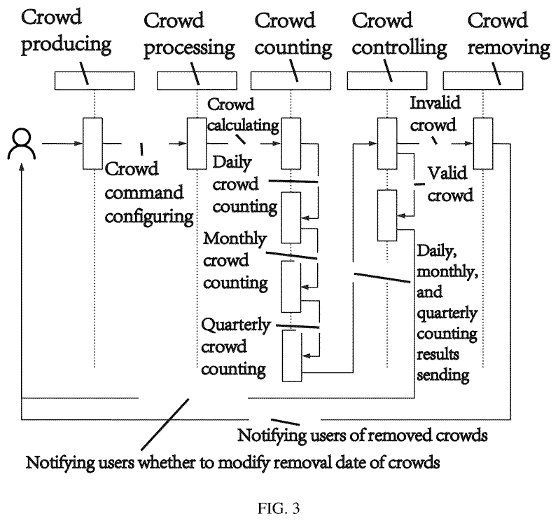

In the embodiments of the present disclosure, a flow of the life cycle of the crowds is shown in FIG. 3, which relates to a processing process of the produced crowds at each stage.
1. Crowd producing module, is used for producing the crowds and configuring the crowd command. A user configures the crowd command, the expiry date, and other information. A default expiry date is three months.
2. Crowd processing module, is used for calculating the crowds, and the calculation is started according to the query statement in the crowd command.
3. Crowd counting module, is used for counting daily, monthly and quarterly crowds.
4. Crowd controlling module, is used for removing the invalid crowds, and notifying the crowds, judging the valid crowds, and then notifying the crowds whether to modify the removal date, and at the same time, controlling the number of total people of the crowds run daily within 500.
5. Crowd removing is to remove the invalid crowds. For example, the number of total execution times of a crowd in the previous two months is lower than 10 times, or the number of total people of a crowd in the latter one month is less than 100,000 users, or the expiry date is reached (remarks: the definition of the invalid crowds can be changed based on a business change). The present disclosure controls the invalid crowds to be removed in a timely manner, primarily solving that the computing and storage resource of the user-profile system is occupied by the invalid crowds, and reducing resource waste, thereby improving resource-utilization rate of the user-profile system, and providing convenience for a user.

### Exemplary Apparatus

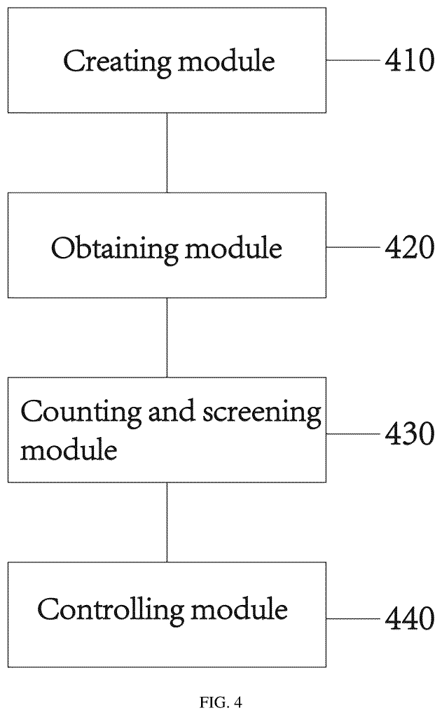

As shown in FIG. 4, an embodiment of the present disclosure provides an apparatus for controlling a life cycle of crowds based on user profile, the apparatus includes:
Creating module, used for creating crowd data, and configuring corresponding crowd command and accessory expiry date for the created crowd data;
Obtaining module, used for obtaining a configured crowd command and an accessory expiry date during a production of crowds, and obtaining a computing cycle of the crowds;
Counting and screening module, used for performing a calculation according to a query statement of the crowd command, and performing a crowd counting for daily, monthly, and quarterly crowds to screen valid crowds and invalid crowds according to a preset rule;
Controlling module, used for controlling the invalid crowds to be removed, judging the valid crowds to determine whether to modify a removal date, and at the same time, controlling the number of total people of the crowds run daily within a preset number, as described above.

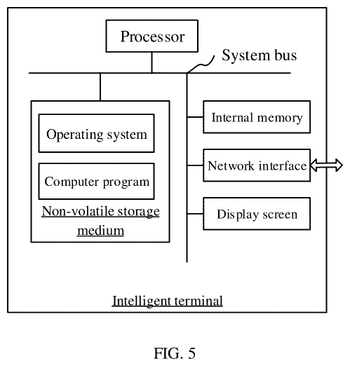

Based on the above embodiments, the present disclosure further provides an intelligent terminal, the functional block of which may be shown in FIG. 5. The intelligent terminal includes a processor, a memory, a network interface, and a display screen all connected through a system bus. Among them, the processor of the intelligent terminal is used to provide computing and controlling capabilities. The memory of the intelligent terminal includes a non-volatile storage medium and an internal memory. The non-volatile storage medium stores an operating system and a computer program. The internal memory provides an environment for an operation of the operating system and the computer program of the non-volatile storage medium. The network interface of the intelligent terminal is used to communicate with an external terminal through a network connection. When the computer program is executed by the processor, a method for controlling the life cycle of the crowds based on user profile is realized. The display screen of the intelligent terminal may be a liquid-crystal display screen or an electronic-ink display screen.

Those skilled in the art can understand that the functional block shown in FIG. 5 is only a block of a partial structure related to a solution of the present disclosure, and does not constitute a limitation on the intelligent terminal to which the solution of the present disclosure is applied. The specific intelligent terminal may include more or fewer components than shown in the figures, or combine some certain components, or have a different arrangement of components.

In one embodiment, an intelligent terminal is provided, including a memory, and one or more programs, among them, the one or more programs are stored in the memory, and by one or more processors executing them one or more programs, the one or more programs are configured to include commands for the following operation:
obtaining a configured crowd command and an accessory expiry date during a production of crowds, and obtaining a computing cycle of the crowds;
performing a calculation according to a query statement of the crowd command, and performing a crowd counting for daily, monthly, and quarterly crowds to screen valid crowds and invalid crowds according to a preset rule;
controlling the invalid crowds to be removed, judging the valid crowds to determine whether to modify a removal date, and at the same time, controlling the number of total people of the crowds run daily within a preset number, as described above.

Those ordinary skilled in the art can understand that all or part of the steps in the above method embodiments can be implemented by commanding relevant hardware through a computer program. The computer program may be stored in a non-volatile computer-readable storage medium, when the computer program is executed, the steps of the above method embodiments are implemented. Among them, any reference to memory, storage, operational database or other medium used in the embodiments provided by the present disclosure may include non-volatile and/or volatile memory. The non-volatile memory may include read-only memory (ROM), programmable ROM (PROM), electrically programmable ROM (EPROM), electrically erasable programmable ROM (EEPROM), or flash memory. The volatile memory may include a random access memory (RAM) or an external cache memory. By way of illustration and not limitation, RAM is available in many forms, such as static RAM (SRAM), dynamic RAM (DRAM), synchronous DRAM (SDRAM), dual operational data rate SDRAM (DDRSDRAM), enhanced SDRAM (ESDRAM), synchlink DRAM (SLDRAM), rambus direct RAM (RDRAM), direct rambus dynamic RAM (DRDRAM), and rambus dynamic RAM (RDRAM), etc.

In summary, the present disclosure discloses a method, apparatus, intelligent terminal, and memory for controlling a life cycle of crowds based on user profile, the method includes steps of: obtaining a configured crowd command and an accessory expiry date during a production of crowds, obtaining a computing cycle of the crowds; performing a calculation based on a query statement of the crowd command, counting daily crowds, monthly crowds, and quarterly crowds to screen valid crowds and invalid crowds based on a preset rule; and controlling the invalid crowds to be removed, judging the valid crowds to determine whether to modify a removal date, at the same time, controlling a quantity of total people of the crowds run daily within a preset number. The present disclosure formulates one set of thorough method for controlling the life cycle of the crowds, and controls the invalid crowds to be removed in a timely manner, primarily solving that the computing and storage resource of the user-profile system is occupied by the invalid crowds, and reducing resource waste, thereby improving resource-utilization rate of the user-profile system, and providing convenience for a user.

Finally, it should be noted that the above embodiments are only used to illustrate the technical schemes of the present disclosure, but not to limit them. Although the present disclosure is described in detail with reference to the foregoing embodiments, those ordinary skilled in the art should understand that: they can make modifications to the technical schemes described in the foregoing embodiments, or make equivalent substitutions to some of the technical features, however, these modifications or substitutions do not cause the essence of the corresponding technical schemes to deviate from the spirit and scope of the technical schemes of the embodiments of the present disclosure.

1-10. (canceled)

11. A method for controlling a life cycle of crowds based on user profile, the method comprising steps of:
obtaining a configured crowd command and an accessory expiry date during a production of crowds, obtaining a computing cycle of the crowds;
performing a calculation based on a query statement of the crowd command, counting daily crowds, monthly crowds, and quarterly crowds to screen valid crowds and invalid crowds based on a preset rule; and
controlling the invalid crowds to be removed, judging the valid crowds to determine whether to modify a removal date, at the same time, controlling a quantity of total people of the crowds run daily within a preset number.

12. The method according to claim 11, wherein before the step of obtaining a configured crowd command and an accessory expiry date during a production of crowds, obtaining a computing cycle of the crowds, the method comprises steps of:
creating crowd data and configuring the corresponding crowd command and the accessory expiry date for the created crowd data.

13. The method according to claim 11, wherein the step of performing a calculation based on a query statement of the crowd command, comprises steps of:
parsing the crowd command, obtaining an execution statement of the crowds for calculation and storage.

14. The method according to claim 11, wherein the step of performing a calculation based on a query statement of the crowd command comprises steps of:
controlling starting a scheduled task, counting the crowds in past one day, the crowds in past one week, the crowds in past one month, and the crowds in past three months, obtaining a quantity of total executed people of the crowds in the past one day, a quantity of total executed people of the crowds in the past one week, a quantity of total executed people of the crowds in the past one month, and a sorting order of quantities of total executed people of each crowd in the past three months respectively, and obtaining both the sorting order of quantities of total executed people of the each crowd in the past three months and the expiry date of the each crowd.

15. The method according to claim 11, wherein the step of counting daily crowds, monthly crowds, and quarterly crowds to screen valid crowds and invalid crowds based on a preset rule comprises steps of:
counting both a sorting order of quantities of total executed people of each crowd in past three months and the expiry date of the each crowd to screen the valid crowds and the invalid crowds; and
if a quantity of total execution times of one crowd in previous two months is less than 10 times, or a quantity of total people of the one crowd in past one month is less than 100,000 users, determining the one crowd as invalid, and issuing a notification at a preset date.

16. The method according to claim 11, wherein the step of counting daily crowds, monthly crowds, and quarterly crowds to screen valid crowds and invalid crowds based on a preset rule comprises steps of:
setting the expiry date of the crowds in advance based on the crowd command to determine the invalid crowds;
determining the invalid crowds based on a query duration of the crowds being higher than a first preset value;
determining the invalid crowds based on a repetition value of the crowds in past three months being lower than a second preset value;
determining the invalid crowds based on both data volume of the crowds being lower than a third preset value, and the crowds being run daily; or
determining the invalid crowds based on the quantity of total people of the crowds run daily being more than 80% of a load of a profile platform.

17. The method according to claim 11, wherein the step of controlling the invalid crowds to be removed, judging the valid crowds to determine whether to modify a removal date, at the same time, controlling a quantity of the crowds run daily within a preset number comprises steps of:
destroying the invalid crowds and modifying the computing cycle to be valid by crowd counting and crowd controlling.

18. An apparatus for controlling a life cycle of crowds based on user profile, the apparatus comprising:
creating module, used for creating crowd data, configuring a corresponding crowd command and an accessory expiry date for the created crowd data;
obtaining module, used for obtaining the configured crowd command and the accessory expiry date during a production of crowds, obtaining a computing cycle of the crowds;
counting and screening module, used for performing a calculation based on a query statement of the crowd command, counting daily crowds, monthly crowds, and quarterly crowds to screen valid crowds and invalid crowds based on a preset rule; and
controlling module, used for controlling the invalid crowds to be removed, judging the valid crowds to determine whether to modify a removal date, at the same time, controlling a quantity of total people of the crowds run daily within a preset number.

19. An intelligent terminal, wherein the intelligent terminal comprises a memory, and one or more programs, wherein the one or more programs are stored in the memory, and are configured to implement the method according to claim 11 when one or more processors execute the one or more programs.
